(19) United States
(12) Patent Application Publication
(10) Pub. No.: US 2026/0201940 A1
(43) Pub. Date: Jul. 16, 2026

(54) FLEXIBLE MULTI-GEAR TRANSMISSION DEVICE FOR A MOTOR VEHICLE HAVING AN ELECTRIFIED DRIVETRAIN AND DRIVETRAIN

(71) Applicant: Schaeffler Technologies AG & Co. KG, Herzogenaurach (DE)

(72) Inventors: Andreas Kinigadner, Erlangen (DE); Martin Laumann, Erlangen (DE)

(73) Assignee: Schaeffler Technologies AG & Co. KG, Herzogenaurach (DE)

(21) Appl. No.: 19/136,335

(22) PCT Filed: Nov. 8, 2023
(86) PCT No.: PCT/DE2023/100831

§ 371 Date: Jun. 6, 2025

(30) Foreign Application Priority Data
Dec. 7, 2022 (DE) 10 2022 132 459.1

(51) Int. Cl. F16H 3/093

(52) U.S. Cl. CPC F16H 3/093; F16H 2200/0021; F16H 2200/0039; F16H 2200/0043; F16H 2200/0047

(57) ABSTRACT

A transmission device for an electrified drive of a motor vehicle is provided. The transmission device has an input shaft, a countershaft arranged parallel to the input shaft, an intermediate shaft arranged coaxially with and axially next to the input shaft, and an output shaft arranged parallel to the input shaft and to the countershaft. On the countershaft, a double gear is arranged, a first tooth region of which meshes with a free gear located on the input shaft and a second tooth region of which meshes with a first toothed region of a three-way freewheel arranged on the intermediate shaft. A second toothed region and a third toothed region of the three-way freewheel further mesh with free gears arranged on the output shaft. At least one fixed gear attached to the intermediate shaft meshes with a further fixed gear or a further free gear of the output shaft.

### CROSS-REFERENCE TO RELATED APPLICATIONS

This application is the United States National Phase of International Application PCT/DE 2023/100831, filed Nov. 8, 2023, which claims priority to German Application 10 2022 132 459.1, filed Dec. 7, 2022. The disclosures of the above applications are incorporated herein by reference.

### TECHNICAL FIELD

The disclosure relates to a transmission device in the form of a multi-gear manual transmission for an electrified, i.e. purely electric and hybrid, drivetrain of a motor vehicle, such as a commercial vehicle (e.g., a truck). In addition, the disclosure relates to a drivetrain that includes the transmission device.

### BACKGROUND

It is already known to use multi-gear transmission devices in commercial vehicles, even in purely electric drivetrains, in order to provide sufficient torque, such as for starting a commercial vehicle. However, it has also been shown that the known two-gear transmissions are not sufficient to handle both the relatively high starting torques, which may be more than 40,000 Nm, and maximum speeds of 85 to 120 km/h. At the same time, the known transmission devices are relatively complex in structure.

### SUMMARY

The present disclosure provides a transmission device which has as many gears as possible, but without having an overly large or complex structure.

One aspect of the disclosure provides a transmission device for an electrified, such as purely electric, drivetrain of a motor vehicle, which has an input shaft, a countershaft arranged parallel to the input shaft, an intermediate shaft arranged coaxially to and axially next to the input shaft and an output shaft arranged parallel to the input shaft and the countershaft. A double gear is arranged on the countershaft, the first tooth region of the double gear meshing with a free gear disposed on the input shaft and the second tooth region of the double gear meshing with a first tooth region of a three-way freewheel arranged on the intermediate shaft. A second tooth region and a third tooth region of the three-way freewheel further meshes with free gears arranged on the output shaft. Furthermore, at least one fixed gear attached to the intermediate shaft meshes with a further fixed gear or a further free gear on/of the output shaft.

This provides a multi-gear transmission structure that is both simple and space-saving in design and is also sufficiently robust for use in commercial vehicles. At the same time, it is possible to switch a sufficient number of gears/overall gear ratios. Therefore, it is advantageous if at least three, more specifically four or five, different overall gear ratios/gears can be selected between the input shaft and the output shaft.

Therefore, it is further advantageous if a first switching apparatus is present which is installed and designed in such a way that in a first switch position it connects the free gear of the input shaft to the input shaft in a rotationally fixed manner, while the intermediate shaft is rotationally decoupled from the input shaft, and in a second switch position it connects the intermediate shaft to the input shaft in a rotationally fixed manner, while the free gear of the input shaft is rotationally decoupled from the input shaft. As a result, a first switching apparatus is used in the most space-saving and effective manner possible between the input shaft and the free gear of the input shaft on the one hand and the input shaft and the intermediate shaft on the other hand.

Furthermore, in some examples, a second switching apparatus is present which is installed and designed in such a way that in a first switch position it connects a first free gear on/of the output shaft, which meshes with a second tooth region of the three-way freewheel, to the output shaft in a rotationally fixed manner, while a second free gear on/of the output shaft is rotationally decoupled from the output shaft, and in a second switch position it connects the second free gear on/of the output shaft, which meshes with a third tooth region of the three-way freewheel, to the output shaft in a rotationally fixed manner, while the second free gear on/of the output shaft is rotationally decoupled from the output shaft. Therefore, a further second switching unit is installed in the most space-saving and effective manner possible between a first free gear on/of the output shaft and the output shaft (itself) on the one hand and between a second free gear on/of the output shaft and the output shaft (itself) on the other hand.

For a simpler structure, it is also advantageous if two fixed gears are arranged on the intermediate shaft, each of which meshes with a further free gear that can optionally be coupled rotationally to the output shaft.

In this context, it is furthermore expedient if a third switching apparatus is present which is installed and designed in such a way that in a first switch position it connects a third free gear, meshing with a first fixed gear of the intermediate shaft, on/of the output shaft to the output shaft in a rotationally fixed manner, while a fourth free gear on/of the output shaft is rotationally decoupled from the output shaft, and in a second switch position it connects the fourth free gear, meshing with a second fixed gear of the intermediate shaft, on/of the output shaft to the output shaft in a rotationally fixed manner, while the third free gear on/of the output shaft is rotationally decoupled from the output shaft. As a result, a third switching apparatus is installed in the most space-saving and effective manner possible between a (further) third free gear on/of the output shaft and the output shaft (itself) on the one hand and between a (further) fourth free gear on/of the output shaft and the output shaft (itself) on the other hand.

Furthermore, it is advantageous if, alternatively or in addition to the third switching apparatus, a fourth switching apparatus is present which is installed and designed in such a way that, in a first switch position, it connects the three-way freewheel to the intermediate shaft in a rotationally fixed manner, while a further free gear, meshing with a fixed gear of the output shaft, on/of the intermediate shaft is rotationally decoupled from the intermediate shaft, and in a second switch position the further free gear, meshing with the fixed gear of the output shaft, on/of the intermediate shaft is connected to the intermediate shaft in a rotationally fixed manner, while the three-way freewheel is rotationally decoupled from the intermediate shaft. This means that a fourth switching apparatus is operatively installed in the most space-saving and effective way possible between the three-way freewheel and the intermediate shaft on the one hand and a further free gear on/of the intermediate shaft and the intermediate shaft on the other hand.

In addition, it is expedient for a multi-gear transmission if the first switching apparatus and/or the second switching apparatus and/or the third switching apparatus and/or the fourth switching apparatus are designed such that at least three, such as four different overall gear ratios/gears can be switched/selected between the input shaft and the output shaft.

Furthermore, the disclosure relates to a drivetrain for a motor vehicle, such as a commercial vehicle, for example a truck, having a transmission device according to the disclosure according to at least one of the previously described examples and an electric machine that can be coupled to the input shaft of the transmission device.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 shows a schematic view of an exemplary three-gear transmission device;

FIG. 2 shows a schematic view of an exemplary four-gear transmission device, wherein, in comparison with FIG. 1, not only two but even three switching apparatuses are present and the additional (third) switching apparatus interacts with two free gears arranged on an output shaft; and

FIG. 3 shows a schematic view of an exemplary transmission device, in which, in comparison with FIG. 1, a further (fourth) switching apparatus is now operatively installed between the three-way freewheel and a further free gear on the intermediate shaft.

The figures are merely schematic in nature and serve solely for understanding the disclosure. Identical elements are provided with the same reference signs.

### DETAILED DESCRIPTION

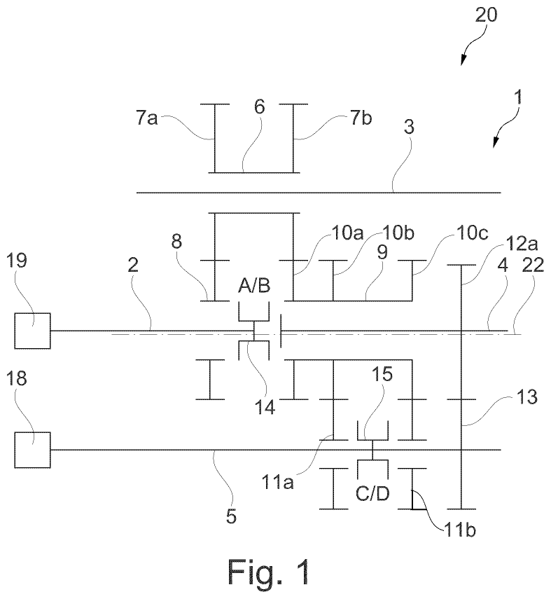

The transmission device 1, as shown schematically in connection with FIG. 1, is designed as a multi-gear, in this example three-gear, manual transmission for a drivetrain 20 of a motor vehicle, namely a truck. The transmission device 1 is thus installed in this drivetrain 20, which drivetrain 20 is indicated in FIG. 1 and, for example, additionally has at least one electric machine 19. The electric machine 19 is an electric drive machine for driving the motor vehicle. The drivetrain 20 is therefore an electric drivetrain 20. The drivetrain 20 can further have a plurality of, for example two, electric machines 19. It is possible to arrange two electric machines 19 in series one behind the other and/or to couple them together with the input shaft 2. Alternatively, it would also be advantageous to couple one electric machine 19 to the input shaft 2, while the other electric machine 19 is coupled to another shaft, such as the intermediate shaft 4. In the case of a hybrid drivetrain, in addition to the electric machine 19 shown, another internal combustion engine may also be present.

The electric machine 19 as well as the optionally present additional electric machine and/or the internal combustion engine can be coupled to an input of the transmission device 1 in the form of an input shaft 2. With its output, here in the form of an output shaft 5, the transmission device 1 is further connected during operation to a differential 18, which is also indicated schematically here.

In some examples, the transmission device 1 has the structure described below. The transmission device 1 has the already mentioned input shaft 2, which is connected during operation to a drive shaft/rotor shaft of the electric machine 19 or can be optionally connected via a clutch. An axis of rotation of the input shaft 2 is indicated by the reference sign 22. A single free gear 8 is arranged on the input shaft 2.

A countershaft 3 is arranged axially parallel to the input shaft 2 (to the axis of rotation 22). The countershaft 3 here has a double gear 6, which is either (as here) arranged rotatably as a free gear on the countershaft 3 designed purely for the bearing function, or is designed as a fixed gear of the countershaft 3, as a result of which the countershaft 3 is then in turn further rotatably mounted in a housing of the transmission device 1.

Furthermore, the transmission device 1 has an intermediate shaft 4 which is offset with respect to the input shaft 2 coaxially and in the axial direction, i.e. viewed along the axis of rotation 22. It can already be seen that a three-way freewheel 9 is arranged on the intermediate shaft 4, which is explained in more detail below. Also in this first example, a fixed gear 12a, which is also referred to below as the first fixed gear 12a, is attached to the intermediate shaft 4.

An output shaft 5 is arranged axially parallel to the input shaft 2 (and thus also to the intermediate shaft 4) and to the countershaft 3. The output shaft 5 forms, as already explained, the output of the transmission device 1 and is further coupled to the differential 18 of the motor vehicle during operation. In this example, two free gears 11a and 11b as well as a fixed gear 13 are arranged/attached on/to the output shaft 5.

With regard to the further mode of operation of the transmission device 1, it can be seen that the free gear 8 of the input shaft 2 permanently meshes with a first tooth region 7a of the double gear 6.

A second tooth region 7b of the double gear 6, which is arranged axially spaced from the first tooth region 7a and, for example, of course, has a different tooth circle diameter than the first tooth region 7a, permanently meshes with a first tooth region 10a of the three-way freewheel 9.

A second tooth region 10b of the three-way freewheel 9, which is again arranged axially offset with respect to the first tooth region 10a of the triple free gear 9, meshes with a first free gear 11a on the output shaft 5. A further, third tooth region 10c of the three-way freewheel 9 meshes with a further second free gear 11b of the output shaft 5. The third tooth region 10c is also axially offset with respect to both the first tooth region 10a and the second tooth region 10b of the three-way freewheel 9.

Finally, the first fixed gear 12a is also arranged axially offset with respect to the three-way freewheel 9. The first fixed gear 12a, which according to the term “fixed gear” is attached in a permanently fixed manner (i.e. also rotationally fixed) to the shaft assigned to it, here the intermediate shaft 4, meshes with a fixed gear 13 of the output shaft 5.

For the sake of completeness, it should be noted that the tooth regions 10a, 10b, 10c of the three-way freewheel 9 also have different pitch circle diameters from one another. The pitch circle diameter of the first fixed gear 12a also naturally differs from that of the tooth regions 10a, 10b, 10c of the three-way freewheel 9. The pitch circle diameters of the free gears 11a and 11b and the fixed gear 13 of the output shaft 5 naturally also differ from each other.

In the first example, a first switching apparatus 14 is also present. The first switching apparatus 14 is operatively installed between the free gear 8 of the input shaft 2 and the input shaft 2 as well as between the input shaft 2 and the intermediate shaft 4.

The first switching unit 14 may be seated in a rotationally fixed manner on the input shaft 2. The first switching apparatus 14 is ultimately designed and arranged such that in a first switch position it connects the free gear 8 of the input shaft 2, which meshes with the double gear 6, to the input shaft 2 in a rotationally fixed manner. In this first switch position, the intermediate shaft 4 is not (directly) rotationally coupled to the input shaft 2 and is thus rotationally decoupled from it. In a second switch position of the first switching apparatus 14, however, the input shaft 2 is directly rotationally connected to the intermediate shaft 4, while the free gear 8 on the input shaft 2 is rotationally decoupled from the input shaft 2.

Furthermore, a second switching apparatus 15 is present, which is operatively installed between the free gear 11a and 11b and the output shaft 5. The second switching unit 15 may be seated in a rotationally fixed manner on the output shaft 5. This results in that the second switching apparatus 15 in a first switch position connects the first free gear 11a on the output shaft 5 to this output shaft 5 in a rotationally fixed manner, while the second free gear 11b is rotationally decoupled from the output shaft 5. In a second switch position of the second switching apparatus 15, the second free gear 11b is connected in a rotationally fixed manner to the output shaft 5, while the first free gear 11a is rotationally decoupled from the output shaft 5.

It should also be noted that each of the switching apparatuses 14 and 15 also has a neutral position. In a neutral position of the first switching apparatus 14, neither the free gear 8 nor the intermediate shaft 4 is rotationally connected to the input shaft 2. In a neutral position of the second switching apparatus 15, neither the first free gear 11a nor the second free gear 11b is connected to the output shaft 5 in a rotationally fixed manner.

In this way, a total of three different overall gear ratios/gears can be realized. In a first gear, the first switching unit 14 and the second switching unit 15 are each in their first position. In a second gear, the first switching apparatus 14 is in the first position, while the second switching apparatus 15 is in the second switch position. In a third gear, the first switching apparatus 14 is then in the second switch position, while the second switching apparatus 15 is in its neutral position. As a result, in this third gear the torque is transmitted via the intermediate shaft 4 and the two meshing fixed gears 12a and 13.

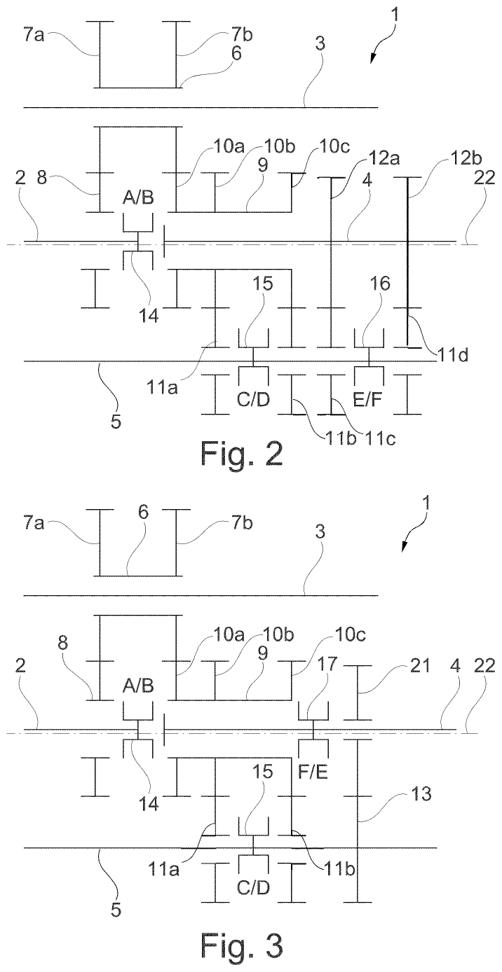

FIG. 2 and FIG. 3 show two further examples. Since the basic structure and the basic mode of operation of these further examples correspond to the first example, only the differences between the transmission device 1 of these further examples and the transmission device 1 of the first examples are described below for the sake of brevity.

As shown in FIG. 2, in addition to the first fixed gear 12a, a second fixed gear 12b, which is arranged axially offset with respect to the first fixed gear 12a, is also fastened to the intermediate shaft 4. Furthermore, each fixed gear 12a, 12b meshes with a further free gear 11c or 11d on the output shaft 5. A third free gear 11c on the output shaft 5 meshes with the first fixed gear 12a and a third free gear 11d on the output shaft 5 meshes with the second fixed gear 12b.

Furthermore, there is a third switching apparatus 16, which is operatively installed between the two third and fourth free gears 11c and 11d and the output shaft 5. This third switching apparatus 16 is seated in a rotationally fixed manner on the output shaft 5. Thus, the third switching apparatus 16 acts in such a way that in its first switch position it connects the third free gear 11c in a rotationally fixed manner to the output shaft 5, while the fourth free gear 11d is rotationally decoupled from the output shaft 5, and in a second switch position it connects the fourth free gear 11d in a rotationally fixed manner to the output shaft 5, while the third free gear 11c is rotationally decoupled from the output shaft 5. The third switching apparatus 16 also forms a neutral position in which neither the third free gear 11c nor the fourth free gear 11d is coupled to the output shaft 5.

Thus, the transmission device 1 of FIG. 2 serves to form four different overall gear ratios/gears. The first and second gears are implemented as described in the first example. The third switching apparatus 16 is in the neutral position in both the first gear and the second gear. A third gear is implemented by the first switching apparatus 14 being in the second switch position, the second switching apparatus 15 being in the neutral position and the third switching apparatus 16 being in the first switch position. A fourth gear is achieved by having the first switching apparatus 14 in the second switch position, the second switching apparatus 15 in the neutral position and the third switching apparatus 16 in its second switch position.

Building on the first example, a further (fourth) switching apparatus 17 is present in FIG. 3. The fourth switching apparatus 17 is installed differently from the third switching apparatus 16 of FIG. 2. With the first switching apparatus 14, the second switching apparatus 15 and the fourth switching apparatus 17, as in FIG. 2, in total only/exclusively three switching apparatuses are used. The fourth switching apparatus 17 is now operatively installed between the three-way freewheel 9 and the intermediate shaft 4 as well as between a further free gear 21 and the intermediate shaft 4. The fourth switching apparatus 17 is seated in a rotationally fixed manner on the intermediate shaft 4. As a result, the fourth switching apparatus 17 is designed such that in a first switch position it couples the three-way freewheel 9 to the intermediate shaft 4 in a rotationally fixed manner, while the further free gear 21 on the intermediate shaft 4 is rotationally decoupled from the intermediate shaft 4 in a rotationally fixed manner, and in a second switch position it connects the further free gear 21 to the intermediate shaft 4 in a rotationally fixed manner, while the three-way freewheel 9 is decoupled from the intermediate shaft 4 in a rotationally fixed manner.

It can also be seen that the additional free gear 21 permanently meshes with the fixed gear 13 on the output shaft 5. Thus, in comparison with FIG. 1, the (first) fixed gear 12a is replaced by the free gear 21 and the fourth switching apparatus 17 is additionally used.

As a result, it is even possible to switch five different gears using this design.

The first and second gears are realized as in FIG. 1, in which the fourth switching apparatus 17 is also in its neutral position, in which neither the three-way freewheel 9 nor the free gear 21 is connected to the intermediate shaft 4 in a rotationally fixed manner. In a third gear, the first switching apparatus 14 is in its second switch position, the fourth switching apparatus 17 is in its first switch position and the second switching apparatus 15 is in its first switch position. In the fourth gear, the first switching apparatus 14 is again in the second switch position, the fourth switching apparatus 17 is in its first switch position and the second switching apparatus 15 is in its second switch position. In a fifth gear, the first switching apparatus 14 is in its second switch position, the fourth switching apparatus 17 is in its second switch position and the second switching apparatus 15 is in its neutral position.

In other words, according to the disclosure, different stages are provided to represent the different gear ratios by using a splitter group and a bypass path which act on a main switch group. Different torque paths can be realized via switching elements (switching apparatuses 14 to 17). The aim here is to keep the tooth engagement as small as possible and, if necessary, to deactivate the splitter group (with countershaft 3). Nevertheless, the possible power paths are intended to be used multiple times in order to keep the number of mechanical components low and to save weight/installation space/costs.

The transmission described above can be followed by a/further range-change group(s) or axle transmission/wheel-selective reduction gear or planetary stage. The transmission is operated to change gears via a gear actuator, not further described here. The transmission can be actively oiled, which means an oil pump device would be required. Otherwise, the transmission is passively lubricated. Transmission concepts that can have 3, 4 or 5 gears are described below.

FIG. 1 shows a 3-gear base: The transmission includes substantially 3 shafts. The drive shaft (input shaft 2) includes a free gear 8 and a shaft part (intermediate shaft 4) which can be connected via the coupling mechanism (first switching apparatus 14) and which is provided with a fixed gear 12a. This fixed gear 12a meshes with a fixed gear 13 on the driven shaft (output shaft 5). The free gear 8 meshes with a gearwheel (first tooth region 7a of the double gear 6) on the additional shaft (countershaft 3). The additional shaft includes a second gearwheel (approximately in the form of a fixed gear; corresponds to the second tooth region 7a of the double gear 6), and this second gearwheel meshes with a tooth system (first tooth region 10a) on the three-way freewheel 9 on the intermediate shaft 4. The other two gearwheel planes (second tooth region 10b and third tooth region 10c) of the three-way freewheel 9 mesh with the free gear 11a and free gear 11b on the driven shaft. Two alternating switching elements (first switching apparatus 14 and second switching apparatus 15) are provided with the following positions: For the first switching apparatus 14: A (first switch position)—neutral (neutral position)—B (second switch position). For the second switching apparatus 15: C (first switch position)—neutral (neutral position)—D (second switch position). Switch positions: AC/AD short gears, B long gear, the splitter group is completely deactivated (stationary) when the switching element C-neutral-D is in neutral.

FIG. 2: An example of FIG. 1 can include in the form that the splitter group is used independently in the switch positions AC and AD. The coupled motion of the splitter group can be avoided here because the three-way freewheel 9 can no longer be coupled to the drive shaft, but the switching element B can now connect the split drive shaft so as to then constitute the bypass. On the connectable shaft (intermediate shaft 4) there are two gearwheel planes that include respective fixed gear/free gear pairs, which can be selected in the switch positions E (first switch position) and F (second switch position) of the third switching apparatus 16. In the switch position BE/BF the long gears can be used, and ideally C/D is in neutral. The ratios of AC and AD are larger than in BE/BF.

FIG. 3: An optimization of the components used is the variant shown in FIG. 2 in which the gearwheel plane F is combined with the wheel plane D. Here, a third switching element (fourth switching apparatus 17) is combined between the intermediate shaft 4 and the multiple free gear. In order to stay with three alternating switching elements here, the sliding sleeve F/E is also positioned completely on the intermediate shaft 4 so that the free gear 21 on the intermediate shaft 4 meshes with the fixed gear 13 on the driven shaft. This allows the fourth switching apparatus 17 to be switched between the switch position E (first switch position) and F (second switch position). For example, AC/AD can be selected as short gears and BFC/BFD/BE as long gears.

A number of implementations have been described. Nevertheless, it will be understood that various modifications may be made without departing from the spirit and scope of the disclosure. Accordingly, other implementations are within the scope of the following claims.

### REFERENCE NUMERALS

1 Transmission device
2 Input shaft
3 Countershaft
4 Intermediate shaft
5 Output shaft
6 Double gear
7a First tooth region of the double gear
7b Second tooth region of the double gear
8 Free gear of the input shaft
9 Three-way freewheel
10a First tooth region of the three-way freewheel
10b Second tooth region of the three-way freewheel
10c Third tooth region of the three-way freewheel
11a First free gear of the output shaft
11b Second free gear of the output shaft
11c Third free gear of the output shaft
11d Fourth free gear of the output shaft
12a First fixed gear of the intermediate shaft
12b Second fixed gear of the intermediate shaft
13 Fixed gear of the output shaft
14 First switching apparatus
15 Second switching apparatus
16 Third switching apparatus
17 Fourth switching apparatus
18 Differential
19 Electric machine
20 Drivetrain
21 Free gear of the intermediate shaft
22 Axis of rotation

1. A transmission device for an electrified drivetrain of a motor vehicle, the transmission device comprising:
an input shaft;
a countershaft arranged parallel to the input shaft;
an intermediate shaft arranged coaxially to and axially next to the input shaft;
an output shaft arranged parallel to the input shaft and the countershaft;
a double gear arranged on the countershaft, the double gear having a first tooth region and a second tooth region, the first tooth region meshing with a free gear disposed on the input shaft, the second tooth region meshing with a first tooth region of a three-way freewheel arranged on the intermediate shaft, and a second tooth region and a third tooth region of the three-way freewheel further meshing with free gears arranged on the output shaft; and
at least one fixed gear attached to the intermediate shaft meshing with a further fixed gear or a further free gear of the output shaft.

2. The transmission device of claim 1, further comprising:
a first switching apparatus installed and designed in such a way that in a first switch position, the first switching apparatus connects the free gear of the input shaft in a rotationally fixed manner to the input shaft, while the intermediate shaft is rotationally decoupled from the input shaft, and in a second switch position, the first switching apparatus connects the intermediate shaft in a rotationally fixed manner to the input shaft, while the free gear of the input shaft is rotationally decoupled from the input shaft.

3. The transmission device of claim 1, further comprising:
a second switching apparatus installed and designed in such a way that in a first switch position, the second switching apparatus connects a first free gear meshing with a second tooth region of the three-way freewheel, of the output shaft to the output shaft in a rotationally fixed manner, while a second free gear of the output shaft is rotationally decoupled from the output shaft, and in a second switch position, the second switching apparatus connects the second free gear, meshing with a third tooth region of the three-way freewheel, of the output shaft to the output shaft in a rotationally fixed manner, while the second free gear of the output shaft is rotationally decoupled from the output shaft.

4. The transmission device of claim 1 further comprising:
two fixed gears arranged on the intermediate shaft, each of the two fixed gears meshes with a further free gear which is coupled rotationally to the output shaft.

5. The transmission device of claim 1, further comprising:
a third switching apparatus installed and designed in such a way that in a first switch position, the third switching apparatus connects a third free gear, meshing with a first fixed gear of the intermediate shaft, of the output shaft to the output shaft in a rotationally fixed manner, while a fourth free gear of the output shaft is rotationally decoupled from the output shaft, and in a second switch position, the third switching apparatus connects the fourth free gear meshing with a second fixed gear of the intermediate shaft, of the output shaft to the output shaft in a rotationally fixed manner, while the third free gear of the output shaft is rotationally decoupled from the output shaft.

6. The transmission device of claim 1, further comprising:
a fourth switching apparatus installed and designed in such a way that in a first switch position, the fourth switching apparatus connects the three-way freewheel in a rotationally fixed manner to the intermediate shaft, while a further free gear, meshing with a fixed gear of the output shaft, of the intermediate shaft is rotationally decoupled from the intermediate shaft, and in a second switch position, the fourth switching apparatus connects the further free gear, meshing with the fixed gear of the output shaft, of the intermediate shaft to the intermediate shaft in a rotationally fixed manner, while the three-way freewheel is rotationally decoupled from the intermediate shaft.

7. The transmission device of claim 1, wherein the first switching apparatus and/or the second switching apparatus and/or the third switching apparatus and/or the fourth switching apparatus are designed such that at least three different overall gear ratios can be selected between the input shaft and the output shaft.

8. A drivetrain for a motor vehicle comprising:
a transmission device according claim 1; and
an electric machine coupled to the input shaft of the transmission device.
